(19) United States
(12) Patent Application Publication
(10) Pub. No.: US 2006/0045402 A1
(43) Pub. Date: Mar. 2, 2006

(54) Bearing arrangement

(75) Inventor: Roger L. Ebaugh, Charlotte, NC (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: INA-Schaeffler KG, Herzogenaurach (DE)

(21) Appl. No.: 11/216,510

(22) Filed: Aug. 31, 2005

Related U.S. Application Data
(60) Provisional application No. 60/605,938, filed on Aug. 31, 2004.

(51) Int. Cl. F16C 19/49

(52) U.S. Cl. 384/494

(57) ABSTRACT

A bearing arrangement with at least one inner ring (1, 2) and a first outer ring (4) arranged coaxial to the inner ring is provided, wherein the outer contours (15) of the at least one inner ring (1, 2) and the inner contours (10) of the first outer ring (4) form a number of bearing receptacles (30), which have conical raceways and axes of symmetry (17) inclined to a main axis (23) of the at least one inner ring (1, 2) or the first outer ring (4).

### FIELD OF THE INVENTION

The invention relates to a bearing arrangement.

### BACKGROUND OF THE INVENTION

Bearing arrangements with multi-row tandem bearing housings are typically used in so-called downhole drilling engines in devices for oil extraction. Such downhole drilling engines have a sealed engine structure with, e.g., three rows of axial cylindrical rollers. Here, there are two rows of cylindrical rollers arranged in tandem for the purpose of mechanically dividing a main axial load. A third row of cylindrical rollers is provided for receiving loads oriented in the reverse direction, so-called “off-bottom” loads. The load distribution between the two rows of cylindrical rollers arranged in cages is realized by selectively dimensioned deflecting spacers and heavy axial plates, which each transfer a load to a set of cylindrical rollers.

### SUMMARY

The invention is based on the objective of improving bearing arrangements starting with the known state of the art.

This objective is solved by a bearing arrangement with the features of the invention.

The invention provides a bearing arrangement with at least one inner ring and a first outer ring arranged coaxial to the inner ring, wherein the outer contours of the one or more inner rings and the inner contours of the first outer ring form a number of bearing receptacles, which have conical raceways and axes of symmetry at an angle to a main axis of the one or more inner rings or the first outer ring.

In addition, a number of axial tapered rollers supported in the bearing receptacles are provided, which are in contact via the raceways with the one or more inner rings and the first outer ring and which are formed for transferring an axial load between this inner ring and the first outer ring. In addition, several inner rings can be arranged next to each other in the axial direction and coaxial to the first outer ring. Thus, the axial load can be distributed among several rows of bearing receptacles arranged one next to the other by the axial tapered rollers held therein.

The invention enables a cageless arrangement of the axial tapered rollers in each axial load-bearing row or main row and thus a maximum load capacity for axial loads and increased fatigue strength. Known cylindrical roller bearings always require a cage for holding the cylindrical rollers. With the present invention, such cages can be eliminated, so that a permissible number of tapered rollers is increased compared with the state of the art and thus the load capacity of each row or each set of axial tapered rollers is increased.

The bearing arrangement according to the invention does not need load-distributing and load-limiting spacers, which are typically required in axial cylindrical roller bearings according to the state of the art. Through the use of cageless bearings, especially axial tapered bearings, the bearing arrangement according to the invention requires a significantly smaller axial installation space in order to achieve the same theoretical load capacity as, e.g., so-called tandem bearings.

In the bearing arrangement according to the invention, each inner ring has an axial end surface, by means of which an axial load, preferably a main axial load originating from an axle shoulder of an adjacent, axial load-transferring functional module, e.g., an axially adjacent inner ring or an engine component, can be transferred into the corresponding inner ring. The inner contours of the first outer ring can have a number of bearing surfaces formed from, e.g., hardened and/or ground bearing steel for defining the raceways of the bearing receptacles. In addition, on the first outer ring there can be a number of raceway flanges for positioning and/or guiding axial tapered rollers. In addition, the first outer ring can have an axial end surface, wherein the main axial load can be transferred between this end surface and a load-bearing shoulder of an engine housing.

The outer contours of the one or more inner rings can also have several bearing surfaces formed, e.g., from hardened and/or ground bearing steel for defining the raceways of the bearing receptacles.

In another configuration of the invention, the bearing arrangement can have a second outer ring, which is formed for receiving an axial load directed opposite the main axial load, a so-called “off-bottom” load. The first and the second outer rings can be fixed to each other by a band with one slot or a clip.

In the configuration of the bearing arrangement according to the invention, the inner contours of the second outer ring can form raceways for ball bearings with the outer contours of an axially adjacent inner ring. Alternatively, for this purpose it can also be provided that the inner contours of the second outer ring form bearing sets with conical raceways, in which axial tapered rollers are held, whose rotational axis is inclined in the opposite direction relative to a main axis of the inner ring or the second outer ring and relative to the axes of symmetry with regard to the main axis, with the outer contours of an adjacent inner ring.

The bearing arrangement according to the invention can be used in a drilling engine with engine components and an engine housing, especially a so-called downhole drilling engine for a drill for oil exploration or oil extraction.

The bearing arrangement according to the invention can be assembled or disassembled again easily in the engine housing. This is possible, because here, end plates, like those that are necessary in the state of the art and that must be mounted manually in an engine housing, are eliminated. In addition, axial loads are not limited by cross sections of spacers that are otherwise used and their material strength. For the invention, axial loading is determined by permissible loading of the axial tapered rollers. Now, preferred load distribution does not have to be performed by extensive calculations of plate or spacer deviations.

### BRIEF DESCRIPTION OF THE DRAWINGS

The invention is explained in more detail below with reference to embodiments. Shown in the associated drawing is:

The FIGURE is a schematic sectional view of a preferred embodiment of a bearing arrangement according to the invention.

### DETAILED DESCRIPTION OF THE PREFERRED EMBODIMENTS

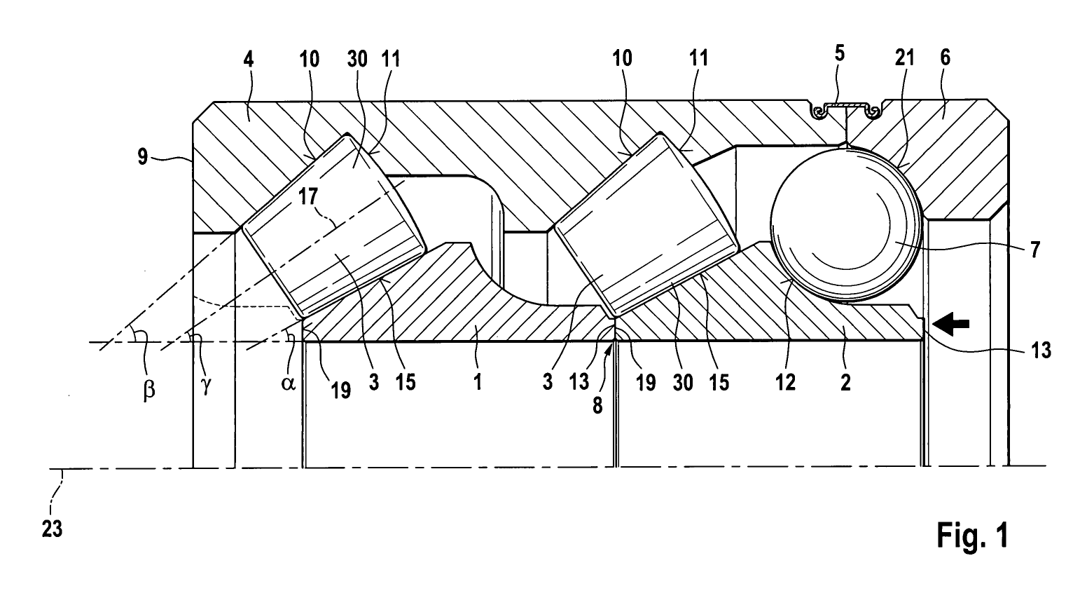

FIG. 1 shows a preferred embodiment of a bearing arrangement according to the invention in a schematic sectional view. This bearing arrangement has two inner rings 1, 2, as well as a first outer ring 4 and a second outer ring 6. The outer contours 15 of the inner rings 1, 2 and also the inner contours 10 of the first outer ring 4 define or form bearing receptacles 30 holding axial tapered rollers 3 which contact both the outer contours 15 of the inner rings and also the inner contours 10 of the first outer ring 4.

In addition, the inner contours 10 of the first outer ring 4 have raceway flanges 11 for positioning and/or guiding the axial tapered rollers 3. In addition, in the present embodiment of the invention, there is a second outer ring 6, whose inner contours 21 form raceways for ball bearings 7 with the outer contours 12 of the inner ring 2 shown on the right in FIG. 1. The first outer ring 4 and the second outer ring 6 are fixed to each other by means of a clip 5. Alternatively, these two outer rings 4, 6 can also be fixed to each other by means of a band with one slot.

The two inner rings 1, 2 are arranged axially one next to the other in the present embodiment of the invention parallel to a main axis 23 of the bearing arrangement. The first outer ring 4 and the second outer ring 6 are arranged coaxial to the two inner rings 1, 2 or the main axis 23 of the bearing arrangement according to the invention. By means of the axial tapered rollers 3 and also the ball bearings 7, the inner rings 1, 2 and also the outer rings 4, 6 can perform a rotational movement relative to each other about the main axis 23 of the bearing arrangement. An axial load acting on the two inner rings 1, 2 in the direction of the arrow is transferred from the two inner rings 1, 2 to the first outer ring 4 by means of the axial tapered rollers 3 arranged and also formed advantageously according to the invention.

Here, an axial end surface 13 of the first inner ring 2 shown on the right in FIG. 1 carries a main axial load, which acts on the two inner rings 1, 2 from a corresponding axle shoulder of a functional module, like an engine component, not shown in FIG. 1. The inner rings 1, 2, which are arranged axially one next to the other, and especially whose conical sections defined by their outer contours 15, transfer the main axial load into the axial tapered rollers 3. The axial tapered rollers 3, which contact the first outer ring 4, guide the axial loads into the outer ring 4.

The outer ring 4 has, in particular, two or more raceways 10 normally manufactured from hardened and/or ground bearing steel and also a raceway flange 11 for each row of axial tapered rollers 3 for positioning and/or guiding these axial tapered rollers 3. The main axial load acting in the direction of the arrow on the right inner ring 2 is distributed onto two inner rings 1, 2 and guided onto both rows of axial tapered rollers 3 and thus onto the outer ring 4. Distribution of the axial load is performed in a region, in which an impact surface 19 of the inner ring 1 arranged on the left meets an end surface 13 of the inner ring 2 arranged on the right. Finally, an axial end surface 9 of the outer ring 4 transfers this main axial load to load-bearing shoulders, which are provided for an engine housing (not shown).

The second outer ring 6 transfers the significantly smaller reverse axial loads through the row of balls 7 and the corresponding raceway 12 to the first inner ring 2 arranged on the right. Such a function can be reinforced through the use of another row of tapered rollers, which are not shown in FIG. 1 and which are arranged inverse to the axial tapered rollers 3, or through a corresponding inclined cylindrical roller bearing or a 90° cylindrical roller bearing according to so-called off-bottom rollers. Here, impact surfaces between the two outer rings 4, 6 can be dimensioned and ground selectively in order to thus achieve an axial pre-tensioning by means of the balls 7 and the raceway 12.

As follows from FIG. 1 in detail, raceways for defining the bearing receptacles 30 along the outer contours 15 of the inner rings 1, 2 relative to a main axis 23 of the bearing arrangement are oriented against a direction of the main axial load indicated by the arrow under an angle α, which is greater than 0° and less than 90°.

Raceways of the bearing receptacles, which are defined by inner contours 10 of the outer ring 4, are inclined relative to the main axis 23 opposite a direction of the main axial load indicated by the arrow under an angle β, which is greater than 0° and also less than 90°. In the present embodiment, the angle β is greater than the angle α. Thus, the axial tapered rollers 3, whose rotational axes 17 corresponding to the axes of symmetry of the bearing receptacles 30 are inclined diagonally under an angle γ, which is greater than 0° and less than 90°, opposite a direction of the main axial load relative to the main axis 23. Here, the axial tapered rollers 3 are arranged such that a frustum-like body of these axial tapered rollers 3 is oriented to taper in the direction of the main axial load. Through this arrangement or configuration, an optimal transfer of the main axial load starting from the inner rings 1, 2 to the first outer ring 4 is possible via the axial tapered rollers 3.

The completed outer ring 4, the axial tapered rollers 3, and the partially completed inner rings 1, 2 can be dimensioned precisely when manufactured one after the other and then can be ground with precision in a region 8, at which an impact surface 19 of the left inner ring 1 contacts an impact surface 13 of the right inner ring 2, in order to thus reach a properly proportioned load distribution on, in this case, the two or possibly more axial raceways along the inner contours 10 of the outer ring 4. As a last assembly part for the bearing arrangement, the preferably round circular band or band with one slot or the formed clip 5, which is or are fixed to the second outer ring 6 on the first outer ring 4, is mounted.

The combination of the ball raceway 12 with the inner ring 2 arranged on the right and also with the second outer ring 6 produces a complete, assembled arrangement, which can be easily installed, e.g., into a drill, even by less experienced users and can be handled easily. Thus, with the present bearing arrangement, no separate assembly of the individual parts shown in FIG. 1 is necessary by the user. In contrast, well trained expert installers, who possess experience in the field of bearings, are required according to the state of the art. However, these experts are not always available at remote oil-drilling locations.

With the bearing arrangement according to the invention, it is possible to compensate for temporary overloads. In conventional tandem bearing receptacles, such overloads lead to damage. In addition, the bearing arrangement has an increased service life. Permissible engine load-bearing numbers are similarly increased. The first outer ring 4 is only at a low risk of breakage due to its configuration.

### LIST OF REFERENCE SYMBOLS

1, 2 Inner ring
3 Axial tapered roller
4 First outer ring
5 Clip
6 Second outer ring
7 Ball bearing
8 Region of impact surfaces
9 End surface
10 Inner contours of the first outer ring
11 Raceway flange
13 End surface
15 Outer contours of the inner ring
17 Rotational axis, axis of symmetry
19 Impact surface
21 Inner contours of the second outer ring
23 Main axis
30 Bearing receptacles
α Angle between the outer contours of an inner ring and the main axis of the bearing arrangement
β Angle between the inner contours of the outer ring and the main axis of the bearing arrangement
γ Angle between the rotational axis of an axial tapered roller or the axis of symmetry of a bearing receptacle and the main axis of the bearing arrangement

1. Bearing arrangement, comprising at least one inner ring (1, 2) and a first outer ring (4) arranged coaxial to the at least one inner ring, wherein outer contours (15) of the at least one inner ring (1, 2) and inner contours (10) of the first outer ring (4) form a number of bearing receptacles (30), which have conical raceways and axes of symmetry (17) inclined to a main axis (23) of the at least one inner ring (1, 2) or the first outer ring (4).

2. Bearing arrangement according to claim 1, further comprising a number of axial tapered rollers (3) in contact with the at least one inner ring (1, 2) and the first outer ring (4) via the raceways, the axial tapered rollers are formed for transfer of an axial load between the at least one inner ring (1, 2) and the first outer ring (4).

3. Bearing arrangement according to claim 1, wherein a plurality of inner rings (1, 2) are arranged axially one next to the other.

4. Bearing arrangement according to claim 3, wherein each of the inner rings (1, 2) has an axial end surface (13), through which an axial load from an axially adjacent shoulder of an axially adjacent functional module can be transferred into the inner ring (1).

5. Bearing arrangement according to claim 1, wherein the contours of the first outer ring (4) have a number of bearing surfaces (10) formed from hardened and/or ground bearing steel for defining the raceways of the bearing receptacles (30).

6. Bearing arrangement according to claim 2, wherein the first outer ring (4) has a number of raceway flanges (11) for positioning and/or guiding the axial tapered rollers (3).

7. Bearing arrangement according to claim 1, wherein the first outer ring (4) has an axial end surface (9), and a main axial load can be transferred between the end surface (9) and a load-bearing shoulder of an engine housing.

8. Bearing arrangement according to claim 1, wherein the contours of the at least one inner ring (1, 2) have several bearing surfaces (15) formed from hardened and/or ground bearing steel, for defining the raceways of the bearing receptacles (30).

9. Bearing arrangement according to claim 1, further comprising a second outer ring (6), which is formed for receiving an axial load directed opposite a main axial load.

10. Bearing arrangement according to claim 9, wherein the first outer ring (4) and the second outer ring (6) are fixed to each other by a band with a slot or a clip (5).

11. Bearing arrangement according to claim 9, wherein inner contours (21) of the second outer ring (6) and outer contours (12) of an adjacent inner ring (2) form raceways for ball bearings (7).

12. Bearing arrangement according to claim 11, wherein the inner contours (21) of the second outer ring (6) form bearing receptacles with conical raceways, in which axial tapered rollers are held, rotational axes of the axial tapered rollers are inclined to a main axis of the inner ring or the second outer ring (6) and are inclined opposite the axes of symmetry (17) with regard to the main axis (23), with the outer contours of the adjacent inner ring (2).

13. Bearing arrangement according to claim 1, wherein the bearing arrangement is installed in a drilling engine.
